(19) United States
(12) Patent Application Publication
(10) Pub. No.: US 2023/0291242 A1
(43) Pub. Date: Sep. 14, 2023

(54) TIME SLICING WIRELESS CHARGING

(71) Applicant: General Electric Company, Schenectady, NY (US)

(72) Inventors: Viswanathan Kanakasabai, Bangalore (IN); Suma Memana Narayana Bhat, Bangalore (IN); Subbarao Tatikonda, Bangalore (IN)

(21) Appl. No.: 18/006,225

(22) PCT Filed: Jul. 15, 2021
(86) PCT No.: PCT/US2021/041845

§ 371 Date: Jan. 20, 2023

(30) Foreign Application Priority Data
Jul. 20, 2020 (IN) 202011030911

(51) Int. Cl. H02J 50/12; H02J 50/40; H02J 7/00

(52) U.S. Cl. CPC H02J 50/12; H02J 50/402; H02J 7/007192; H02J 7/0048; H02J 7/00712

(57) ABSTRACT

This disclosure provides systems, methods, and apparatuses for wireless power transmission. Various implementations of this disclosure relate generally to intermittent wireless charging. A wireless power transmission apparatus (such as a charging pad or surface) can intermittently provide wireless power to one or more wireless power reception apparatuses based on time slices. The wireless power reception apparatuses can cool during time slices in which wireless power is not transferred. A power control unit of the wireless power transmission apparatus may determine first time slices during which wireless power will be provided to the wireless power reception apparatus. The power control unit also may determine second time slices during which wireless power will not be provided to the wireless power reception apparatus, where the second time slices are interspersed with the first time slices allowing time for thermal loads that accumulated during the first time slices to dissipate.

### TECHNICAL FIELD

This disclosure relates generally to wireless power, and more specifically, to a wireless power transmission apparatus.

### DESCRIPTION OF THE RELATED TECHNOLOGY

Conventional wireless power systems have been developed with a primary objective of charging a battery in a wireless power reception apparatus, such as a mobile device, a small electronic device, gadget, or the like. In a conventional wireless power system, a wireless power transmission apparatus may include a primary coil that produces an electromagnetic field and a charging surface on which wireless power reception apparatuses are placed. The electromagnetic field may induce a voltage in a secondary coil of the wireless power reception apparatus when the secondary coil is placed in proximity to the primary coil. In some instances, the voltage is induced when the wireless power reception apparatus is placed on the charging surface of the wireless power transmission apparatus. In this configuration, the electromagnetic field may wirelessly transfer power to the secondary coil. The power may be transferred using resonant or non-resonant inductive coupling between the primary coil and the secondary coil. In some instances, the power also may be transferred continuously without interruption. As the wireless power transmission apparatus continuously transmits power to the wireless power reception apparatus, temperature of charging surface, transmission coil, reception coil or their associated electronics may rise beyond acceptable limits.

### SUMMARY

The systems, methods and apparatuses of this disclosure each have several innovative aspects, no single one of which is solely responsible for the desirable attributes disclosed herein.

One innovative aspect of the subject matter described in this disclosure can be implemented in a wireless power transmission apparatus. In some implementations, the wireless power transmission apparatus may include a first primary coil of a plurality of primary coils configured to transmit a first wireless power to a first wireless power reception apparatus. The wireless power transmission apparatus also may include a power control unit configured to detect the first wireless power reception apparatus in proximity to the first primary coil of the wireless power transmission apparatus, and determine first time slices during which to power the first primary coil to cause the first primary coil to transmit the first wireless power to the first wireless power reception apparatus.

In some implementations, the power control unit may be further configured to determine second time slices during which to cease transmission of the first wireless power to the first wireless power reception apparatus, wherein the first time slices are interspersed with the second time slices, and cause the first primary coil to cease transmission of the first wireless power to the first wireless power reception apparatus during the second time slices.

In some implementations, a battery may be associated with the first wireless power reception apparatus, wherein the battery is configured to charge up to a first percentage of battery capacity in a first time period, where the first time period is substantially similar to a second time period for continuously charging the battery up to the charge percentage.

In some implementations, the cessation of transmission of the first wireless power may keep a temperature below a thermal limit in one or more of an interface surface, a transmitter coil, a receiver coil, and electronics in the wireless power transmission apparatus.

In some implementations, the power control unit may be further configured to determine, during one or more of the first time slices, that a thermal limit has been exceeded, and cease, in response to the determination that thermal limit has been exceeded, provision of the first wireless power to the first wireless power reception apparatus during the one or more of the first time slices.

In some implementations, the thermal limit may indicate a maximum temperature of an interface surface of the wireless power transmission apparatus.

In some implementations, the wireless power reception apparatus may be associated with a device rating, and where a duration of the first time slices is based, at least in part, on the device rating.

In some implementations, the power control unit may be further configured to detect a second wireless power reception apparatus in proximity to a second primary coil of the plurality of primary coils, and determine second time slices during which to power the second primary coil to cause the second primary coil to transmit a second wireless power to the second wireless power reception apparatus, wherein the second time slices are interspersed with the first time slices. The second primary coil may be configured to transmit the second wireless power to the second wireless power reception apparatus.

In some implementations, the power control unit may be further configured to determine that a battery charge threshold associated with the second wireless power reception apparatus has been exceeded, and cause the second primary coil to cease transmission of the second wireless power during one or more of the second time slices in response to the determination that the battery charge threshold has been exceeded. The second primary coil may be further configured to cease transmission of the second wireless power to the second wireless power reception apparatus in response to the determination that the battery charge threshold has been exceeded.

In some implementations, each of the first time slices has a first duration and each of the second time slices may have a second duration, and the power control unit may be further configured to determine a charge state of a battery associated with the second wireless power reception apparatus, increase the first duration based on the charge state, and decrease the second duration based on the charge state.

In some implementations, each of the first time slices is of a first duration and each of the second time slices is of a second duration, and the power control unit may be further configured to determine a user-configurable charging priority associated with the second wireless power reception apparatus, and modify the first duration based on the user-configurable charging priority.

In some implementations, the wireless power transmission apparatus also may include a first user interface (UI) configured to present indicia indicating charging status of at least one of the first primary coil and the second primary coil.

In some implementations, the wireless power transmission apparatus also may include another power control unit configured to detect a second wireless power reception apparatus in proximity to a second primary coil of the plurality of primary coils, determine second time slices during which to power the second primary coil to cause the second primary coil to transmit a second wireless power to the second wireless power reception apparatus, and provide the second wireless power to the second primary coil during the second time slices. The second primary coil may be configured to transmit the second wireless power to the second wireless power reception apparatus.

In some implementations, the second time slices are interspersed with the first time slices.

In some implementations, the wireless power transmission apparatus may include another power control unit configured to power the first primary coil during the first time slices, where the first wireless power is based on power from each of the power control units

Another innovative aspect of the subject matter described in this disclosure can be implemented as a method. The method may include operations for performing any features of the above-mentioned wireless power transmission apparatuses.

Another innovative aspect of the subject matter described in this disclosure can be implemented as a computer-readable medium having stored therein instructions which, when executed by a processor, causes the processor to perform operations for performing any features of the above-mentioned wireless power transmission apparatuses.

Another innovative aspect of the subject matter described in this disclosure can be implemented as a system having means for implementing any operations for performing any features of the above-mentioned wireless power transmission apparatuses.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example wireless power system that includes a wireless power transmission apparatus capable of charging multiple wireless power reception apparatuses.

FIG. 2 shows an example wireless power transmission apparatus having multiple layers of primary coils arranged in an overlapping pattern.

FIG. 3 is a block diagram illustrating an example wireless power transmission apparatus.

FIG. 4A is an example graphical representation of intermittent wireless power transfer from a wireless power transmission apparatus to a wireless power reception apparatus.

FIG. 4B is an example graphical representation of charging status resulting from intermittent wireless power transfer between a wireless power transmission apparatus and a wireless power reception apparatus.

FIG. 5A is an example graphical representation of power-related time slicing associated with charging a single wireless power reception apparatus.

FIG. 5B is an example graphical representation of power-related time slicing associated with charging two wireless power reception apparatuses.

FIG. 5C is an example graphical representation of dynamically updating a schedule of time slices upon detection of an additional wireless power apparatus.

FIG. 6 is a block diagram illustrating a wireless power transmission apparatus in which a power control unit can independently control different transmitter circuits.

FIG. 7 is a block diagram illustrating a wireless power transmission apparatus in which multiple power control units can cooperatively provide power to a transmitter circuit.

FIG. 8 is a flow diagram illustrating example operations of a process for providing wireless power to a wireless power reception apparatus

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any means, apparatus, system or method for transmitting or receiving wireless power.

A conventional wireless power system may include a wireless power transmission apparatus and one or more wireless power reception apparatuses. The wireless power transmission apparatus may include one or more primary coils that transmits wireless energy to one or more corresponding secondary coils in the wireless power reception apparatus. A primary coil refers to a source of wireless energy (such as inductive or magnetic resonant energy) in a wireless power transmission apparatus. A secondary coil in the wireless power reception apparatus receives the wireless energy.

Wireless power transmission may be more efficient when the primary and secondary coils are closely positioned. Conversely, the efficiency may decrease when the primary and secondary coils are misaligned. Inefficiencies in wireless power transfer may cause temperatures to increase on a charging surface of the wireless power transmission apparatus or in various components of the wireless power system. This problem may be compounded when multiple devices are placed on a charging pad. In some instances, even with relatively efficient transfer of wireless power, components in the wireless power system may exhibit relatively high temperatures. As temperatures rise, heat may build-up beyond critical limits, causing system failure.

Some wireless power reception apparatuses may be associated with different preferences, priorities, and requirements. For example, a user may want to quickly charge devices of a first type at a relatively high power level and slowly charge devices of a second type at lower power levels. Similarly, when charging multiple devices, the user may want to assign higher priority to certain devices and lower priority to others. For example, the user may assign highest priority to a first mobile phone and lower priorities to other mobile phones, where higher priority devices receive more wireless power than lower priority devices.

Various implementations of this disclosure relate generally to intermittent wireless charging in a wireless power transmission apparatus. Some implementations more specifically relate to a wireless power transmission apparatus (such as a charging pad or surface) that intermittently provides wireless power to one or more wireless power reception apparatuses to enable the wireless power reception apparatuses to cool during time slices in which wireless power is not transferred. In this disclosure, a time slice is a time period of a particular duration. Some implementations also may relate to a wireless power transmission apparatus that intermittently provides wireless power to support various charging profiles for different wireless power reception apparatuses. In accordance with this disclosure, a wireless power transmission apparatus may include a power control unit that may detect a wireless power reception apparatus in proximity to a primary coil. The power control unit may determine first time slices during which wireless power will be provided to the wireless power reception apparatus. The power control unit also may determine second time slices during which wireless power will not be provided to the wireless power reception apparatus, where the second time slices are interspersed with the first time slices. During the second time slices (no power provided), thermal loads that accumulated during the first time slices (wireless power provided) may dissipate.

In some implementations, the power control unit may detect multiple wireless power reception apparatuses. The power control unit also may determine different time slices for each of the multiple wireless power reception apparatuses. For example, the power control unit may detect a first wireless power reception apparatus and a second wireless power reception apparatus. The power control unit may determine first time slices for the first wireless power reception apparatus and second time slices for the second wireless power reception apparatus, where the first time slices are of a first duration and the second time slices are of a second duration. The power control unit may determine the duration for the first and second time slices based on one or more factors including user charging preferences, device priority, battery charge state, thermal information, or other suitable factors related to providing wireless power to a load. The thermal information may be associated with the power reception apparatuses, the interface surface, the primary coil, or any combination thereof.

In some implementations, the wireless power transmission apparatus may include a single power control unit to control a plurality of primary coils. The power control unit may use time division multiplexing to control one or more of the primary coils and deliver wireless power to one or more power wireless power reception apparatuses. For example, during the first time slices, the power control unit may cause the first primary coil to transmit wireless power to a first wireless power reception apparatus. During the second time slices, the power control unit may cause a second primary coil to transmit wireless power to the corresponding second wireless power reception apparatus. The first and second time slices may be interspersed so that provision of wireless power alternates between the first and second wireless power receiving apparatus.

In some implementations, the wireless power transmission apparatus may include multiple power control units to control multiple primary coils. When charging a single wireless power reception apparatus, multiple power control units may cooperatively provide more wireless power to the single wireless power reception apparatus than would be provided using fewer power control units. For example, two power control units may control a single primary coil to provide more wireless power to a wireless power reception apparatus. If only one power control unit were to control the single primary coil, less wireless power would be provided. As a result, the wireless power transmission apparatus may utilize multiple power control units to provide additional wireless power to a wireless power reception apparatus.

In some implementations, the wireless power transmission apparatus may include a user interface to present content related to charging one or more wireless power reception apparatuses. The user interface may include components suitable for presenting the content, such as display devices and audio presentation devices. The content may indicate charging status of a particular wireless power reception apparatus, faults arising during charging of a particular wireless power reception apparatus, status of a wireless power reception apparatus waiting for the charging to continue, whether the wireless power transmission apparatus is currently transmitting wireless power to a particular wireless power reception apparatus, or any combination thereof.

Particular implementations of the subject matter described in this disclosure can be implemented to realize one or more of the following potential advantages. In some implementations, the described techniques can be used to reduce thermal loads that may arise when charging of one or more wireless power reception apparatuses. The thermal loads may be reduced by intermittently providing wireless power to one or more wireless power reception apparatuses. Reducing thermal loads may reduce charging faults, avoid system failures, and more quickly charge batteries compared to other types of systems with reduced charge rates at elevated temperatures.

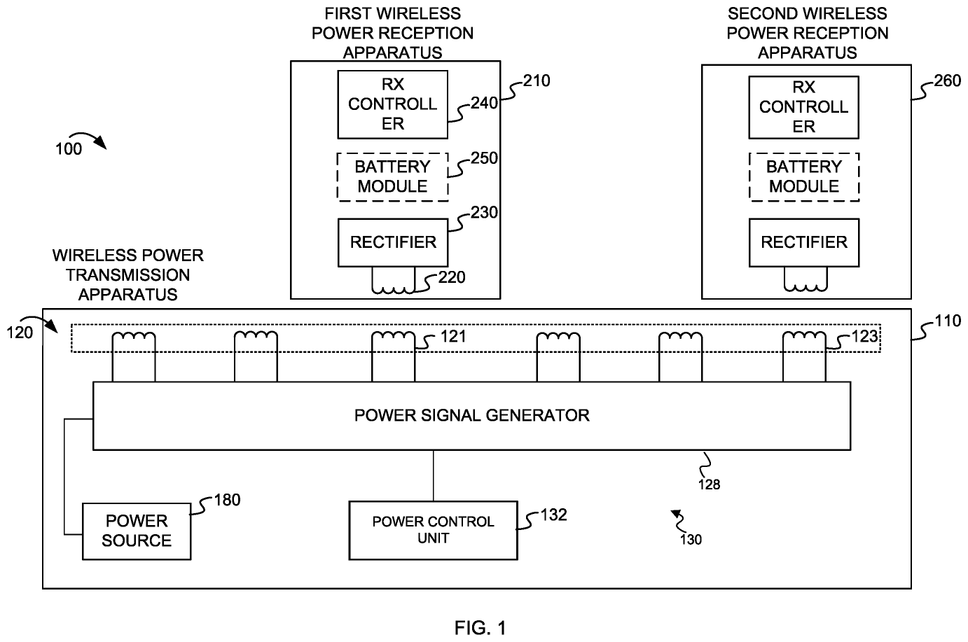

FIG. 1 shows an example wireless power system that includes a wireless power transmission apparatus capable of charging multiple wireless power reception apparatuses. The wireless power system 100 includes a wireless power transmission apparatus 110 which has multiple primary coils 120 including primary coils 121 and 122. The primary coils 120 may be associated with a power signal generator 128. Each primary coil 120 may be a wire coil which transmits wireless power (which also may be referred to as wireless energy). Each primary coil 120 may transmit wireless energy using inductive or magnetic resonant field. The power signal generator 128 may include components (not shown) to prepare the wireless power. For example, the power signal generator may include one or more switches, drivers, a series capacitor, or other components.

The power signal generator 128, power control unit 132 and other components (not shown) may be collectively referred to as transmitter circuit 130. Some or all of the transmitter circuit 130 may be embodied as an integrated circuit (IC) that implements features of this disclosure for intermittently providing wireless power to one or more wireless power reception apparatuses. The power control unit 132 may be implemented as a microcontroller, dedicated processor, integrated circuit, application specific integrated circuit (ASIC) or any other suitable electronic device.

The power source 180 may provide power to the transmitter circuit 130 in the wireless power transmission apparatus 110. The power source 180 may convert alternating current (AC) to direct current (DC).

The power control unit 132 may detect the presence or proximity of a wireless power reception apparatus. For example, the power control unit 132 may cause the primary coils 120 to periodically transmit a detection signal and measure for a change in coil current or load that indicates an object near the primary coil. The power control unit 132 may determine when a wireless power reception apparatus is placed in proximity to one or more primary coils 120. For example, the power control unit 132 may cause a primary coil 120 to periodically transmit a detection signal and measure for a change in coil current or load that indicates an object near the primary coil 120. In some implementations, the power control unit 132 may detect a ping, wireless communication, load modulation, or the like.

In the example of FIG. 1, the power control unit 132 may detect a first wireless power reception apparatus 210 at a first primary coil 121. The first wireless power reception apparatus 210 may include a secondary coil 220. A wireless power reception apparatus may be any type of device capable of receiving wireless power, including a mobile phone, computer, laptop, peripheral, gadget, robot, vehicle, or the like. When a wireless power reception apparatus (such as the first wireless power reception apparatus 210) is placed on the wireless power transmission apparatus 110 near the first primary coil 121, the power control unit 132 may detect its presence. For example, during a detection phase, the first primary coil 121 may transmit a detection signal (which also may be referred to as a ping). The coil current at the first primary coil 121 may be measured to determine whether the coil current has crossed a threshold indicating an object in the electromagnetic field of the first primary coil 121. If an object is detected, the power control unit 132 may wait for a handshake signal from the first wireless power reception apparatus 210 (such as an identification signal or setup signal) to determine whether the object is a wireless power reception apparatus or a foreign object. The handshake signal may be communicated by the first wireless power reception apparatus 210 using a series of load changes (such as load modulations). The load changes may be detectable by a coil voltage or current sensing circuit and interpreted by the power control unit 132. The power control unit 132 may interpret the variations in the load to recover the communication from the first wireless power reception apparatus 210. The communication may include information such as charging level, requested voltage, received power, receiver power capability, support for a wireless charging standard, or the like.

The first wireless power reception apparatus 210 may include a secondary coil 220, a rectifier 230, a receive (RX) controller 240 and an battery module 250. In some implementations, the battery module 250 may have an integrated charger (not shown). The secondary coil 220 may generate an induced voltage based on the received wireless power from the first primary coil 121. A capacitor (not shown) may be in series between the secondary coil 220 and the rectifier 230. The rectifier 230 may rectify the induced voltage and provide the rectified voltage to the battery module 250. The battery module 250 may be in the wireless power reception apparatus 210 or may be an external device that is coupled by an electrical interface. The battery module 250 may include a charger stage, protection circuits such as a temperature-detecting circuit, and overvoltage and overcurrent protection circuits. Alternatively, the receive controller 240 may include a battery charging management module to collect and process information on a charging state of the battery module 250. In some implementations, the receive controller 240 may be configured to communicate with the power control unit 132 using load modulation via the secondary coil 220.

In the example of FIG. 1, the power control unit 132 may detect the wireless power reception apparatus 210 at the first primary coil 121. In response, the power control unit 132 may determine first time slices during which wireless power will be provided to the wireless power reception apparatus 210. The power control unit 132 also may determine second time slices during which no wireless power will be provided to the wireless power reception apparatus 210. The first and second time slices may be interspersed so the first primary coil 121 intermittently provides wireless power to the first wireless power reception apparatus 210. For example, the first time slices may have a duration of five minutes and the second time slices may have a duration of two minutes. Based on the time slices, the power control unit 132 may intermittently activate the first primary coil 121 to provide wireless power during the first time slice (five minutes) and deactivate the first primary coil 121 so no wireless power is provided during the second time slice (two minutes). For any suitable number of first and second time slices, the power control unit 132 may repeatedly alternate between power-on time slices and power-off time slices. In some instances, the power control unit 132 may determine the number of power-on and power-off time slices based on information about a battery associated with the first wireless power reception apparatus 210.

As another example, the power control unit 132 may detect the second wireless power reception apparatus 260 in addition to the first wireless power reception apparatus 210. The power control unit 132 may intermittently provide wireless power to each of the first and second wireless power reception apparatuses (210 and 260, respectively). For example, the power control unit 132 may determine first time slices during which the first primary coil 121 provides wireless power to the first wireless power reception apparatus 210. Additionally, the power control unit may determine second time slices during which a second primary coil 122 provides wireless power to the second wireless power reception apparatus 260. In some instances, the first time slices and the second time slices may have different durations, and the first time slices may be interspersed with the second time slices. For example, the first time slices may be two minutes in duration, and the second time slices may be three minutes in duration. By controlling the first and second primary coils (121 and 122, respectively) according to the interspersed first and second time slices, the power control unit 132 may cause the first primary coil 121 to provide wireless power to the first wireless power reception apparatus 210 for two minutes. During those two minutes, no power is provided to the second wireless power reception apparatus 260. After the first time slice, the power control unit 132 may provide wireless power to the second wireless power reception apparatus 260 during the second time slice, which has a three-minute duration. During those three minutes, no power is provided to the first wireless power reception apparatus 210. For any suitable number of time slices, the power control unit 132 may intermittently provide wireless power to the first and second wireless power reception apparatuses (201 and 260, respectively). The power control unit 132 may control any suitable number of primary coils to intermittently provide wireless power to any suitable number of wireless power reception apparatuses.

The power control unit 132 may customize any suitable aspect of the wireless power. In some instances, the power control unit 132 may determine wattages, time slice durations, device priorities, device types, and other information about devices detected on the charging pad. For example, the power control unit 132 may detect a mobile telephone on the charging pad. For that mobile telephone, the power control unit 132 may select a five-minute power-on time slice during which wireless power reception apparatus provides 15 Watts (W) of wireless power. Additionally, the power control unit 132 may select a two-minute power-off time slice during which wireless power reception apparatus provides no power. The power control unit 132 may customize power-off time slices based on any suitable information, such as how many devices are on the charging pad, aspects of power-on time slices (such as wattage, duration, etc.) and device type.

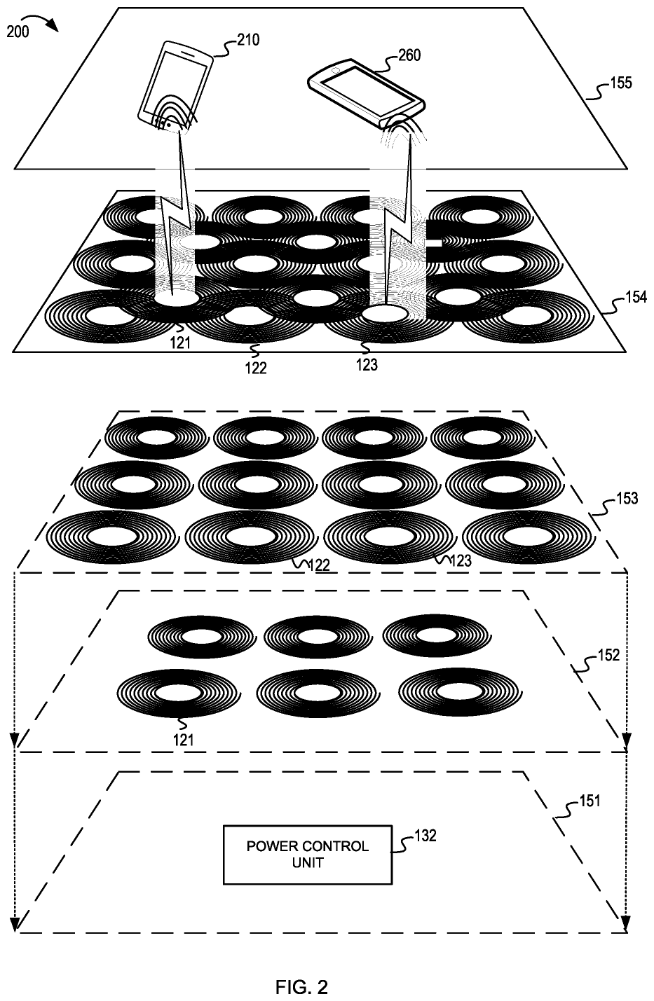

FIG. 2 shows an example wireless power transmission apparatus having multiple layers of primary coils arranged in an overlapping pattern. The example wireless power transmission apparatus 200 includes 18 primary coils arranged in two overlapping layers. However, the quantity and arrangement of primary coils are provided as an example. Other quantities of primary coils, number of layers, or arrangements may be possible.

In FIG. 2, the power control unit 132 resides at the bottom 151. The first primary coil 121 is shown on the first layer 152, along with several other primary coils. The second primary coil 122 is shown on the second layer 153 with other primary coils. A combined view 154 shows the coils in overlapping fashion. Again, this depiction is provided for ease of illustration. In some implementations, the quantity of coils and overlap may be such that there are few or no dead zones in the charging surface 155. In addition to the wireless power transmission apparatus 200, FIG. 2 shows the first wireless power reception apparatus 210 and the second wireless power reception apparatus 260 placed on the charging surface 155. The first wireless power reception apparatus 210 is able to latch with and receive wireless power from the first primary coil 121 based on its position over that transmitter circuit. Similarly, the second wireless power reception apparatus 260 may latch with and receive wireless power from the third primary coil 123.

Various optional features may be incorporated into the design of the wireless power transmission apparatus. For example, in some implementations, ferrite material may be used in portions of the wireless power transmission apparatus to maintain a magnetic field with no (or few) dead zones. In some implementations, the primary coils may have no overlap. In some implementations, ferrite material may be used under the primary coils with no overlap. In some implementations, the shape of the coils, amount of overlap, and materials may be selected to improve efficiency, reduce dead zones, or both.

Although described as a charging pad, the structure of the wireless power transmission apparatus may be different. For example, the wireless power transmission apparatus may be located in a vehicle, a piece of furniture, a part of a wall, a floor, or the like. In some implementations, the wireless power transmission apparatus may be integrated as part of a table-top, coffee table, desk, counter, or the like.

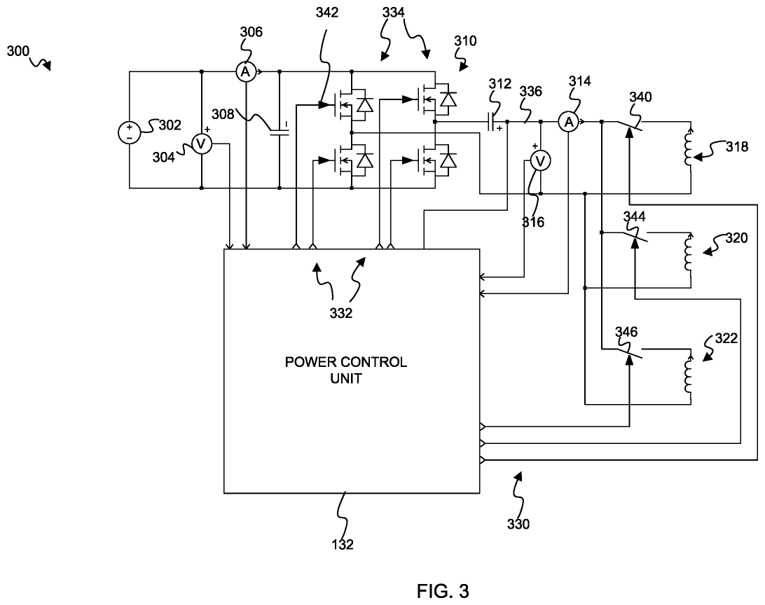

FIG. 3 is a block diagram illustrating an example wireless power transmission apparatus. The wireless power transmission apparatus 300 may include a power source 302. In some implementations, the power source 302 may be an AC-DC converter operating from AC supply mains. In some implementations, the power source 302 may include a DC-DC power source operating from a DC input. The power source 302 may provide the DC power to an inverter 310, which converts the DC power into AC power. The inverter 310 may provide the AC power to a common bus 336. A power control unit 132, a transmitter circuit 318, the transmitter circuit 320, and a transmitter circuit 322 may be connected to and receive power and signals from the common bus 336. There is a first capacitor 308 connected to the power source 302 and a series capacitor 312 connected to the common bus 336. For example, the series capacitor 312 may form a resonant tank with the inductance of the active one of the transmitter circuit 318, 320 or 322.

The power control unit 132 may receive voltage information from a first voltage sensor 304 connected to the power source 302 and current information about current from a first current sensor 306 connected to the power source 302. The voltage and current information from the first voltage sensor 304 and the first current sensor 306, respectively, may be used to compute the power input to the transmitter apparatus 300. The power control unit 132 also may receive voltage information from a second voltage sensor 316 connected to the common bus 336 and current information about current from a second current sensor 314 connected to the common bus 336. The voltage and current information from the second voltage sensor 316 and the second current sensor 314, respectively, may be used by the power control unit to demodulate the information communicated in the form of packets from the power receiver to the power transmitter. The power control unit 132 may include one or more driver units that enable controlling switches 334 in the inverter 310. The switches 334 may be metal-oxide-semiconductor field-effect transistors (MOSFETs) or any other suitable switching devices. The power control unit 132 also may control the transmitter circuits (318, 320, and 322) via the control lines 330 from their respective drivers included in the power control unit 132 to enable or disable switches 340, 344 and 346, respectively.

The power control unit 132 may determine time slices to control provision of wireless power to wireless power reception apparatuses that may latch with the transmitter circuits 318, 320 and 322. As described herein, using the time slices, the power control unit 132 may cause one or more of the transmitter circuits 318, 320 and 322 to intermittently provide power to one or more wireless power reception apparatuses. The power control unit 132 may select or otherwise customize various aspects of the wireless power provided to the wireless power reception apparatuses. For example, the power control unit 132 may determine the time slices and other aspects of the wireless power based on device priorities, device types, battery charge states, thermal profiles and any other suitable information relevant to providing wireless power to a load.

The power control unit 132 may be implemented using one or more microcontrollers, application specific integrated circuits (ASICs), field programmable gate arrays (FPGAs), microprocessors, or any other suitable device.

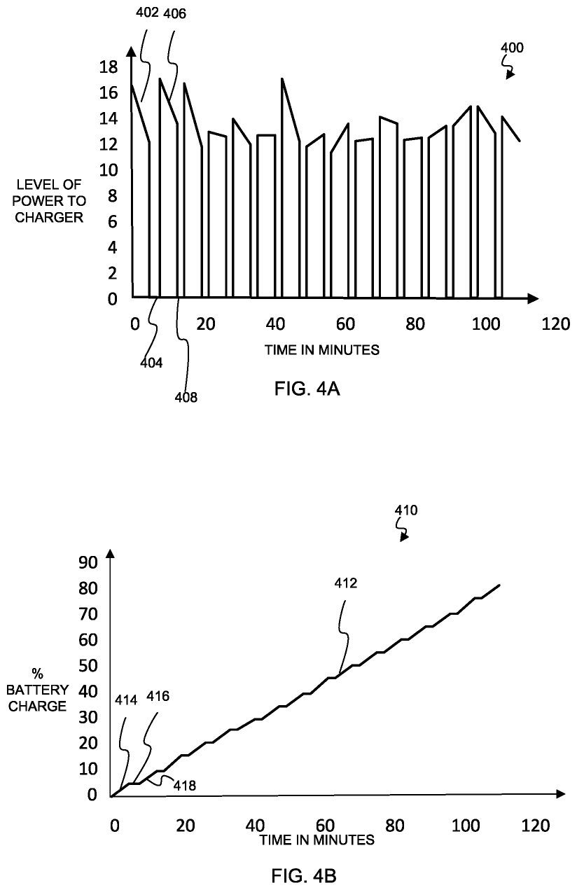

FIG. 4A is an example graphical representation of intermittent wireless power transfer from a wireless power transmission apparatus to a wireless power reception apparatus. A graph 400 shows a power level during alternating power-on and power-off time slices. In the graph 400, an X axis indicates increasing time in minutes, and a Y axis indicates level of power to a battery charger. The power-on time slices have a duration of five minutes and the power-off time slices have a duration of two minutes. During a first power-on time slice 402, the power control unit 132 may cause a transmitter circuit to transmit wireless power to a wireless power reception apparatus. During the first power-on time slice 402, the power level begins at approximately 16 W and decreases to 12 W over the five-minute duration of the time slice. After the first power-on time slice 402, there is a first power-off time slice 404. During the first power-off time slice 404, the power level immediately falls to zero because the power control unit is not providing wireless power to the wireless power reception apparatus. After the first power-off time slice 404, there is a second power-on time slice 406. During the second power-on time slice 406, the wireless power begins at approximately 17 W and decreases to approximately 14 W over the five-minute duration of the second power-on time slice 406. After the second power-on time slice 406, there is a second power-off time slice during which no wireless power is provided. As shown, the power control unit 132 may alternate between a plurality of power-on time slices and a plurality of power-off time slices. For each of the 16 power-on time slices in the graph 400, the wireless power may begin at a suitable power level and may linearly increase or decrease over the duration of the power-on time slice. For each of the 15 power-off time slices in the graph 400, there is no power provided to the charger. By alternating between power-on and power-off time slices, the wireless power transmission apparatus may dissipate heat that has accumulated during the power-on time slices.

FIG. 4B is an example graphical representation of charging status resulting from intermittent wireless power transfer between a wireless power transmission apparatus and a wireless power reception apparatus. A graph 410 shows a curve 412 depicting increasing battery charge over time. In the graph 410, an X axis indicates increasing time in minutes, and a Y axis indicates increasing percentage of battery charge. More specifically, the curve 412 shows how battery charge may increase when a power control unit provides intermittent power by alternating between power-on and power-off time slices. In the graph 410, the power-on time slices have a duration of five minutes, and the power-off time slices have a duration of two minutes. During the first five-minute power-on time slice 414, the battery charge increases from 0% to approximately 5% of a battery charge capacity. After the first five-minute power-on time slice 414, there is a two-minute power-off time slice 416. During the first two-minute power-off time slice 416, the battery charge level remains at 5% of battery charge capacity. After the first two-minute power-off time slice 416, there is a second five-minute power-on time slice 418. During the second five-minute power-on time slice 418, the battery charge increases to approximately 10% of the battery capacity.

According to the curve 412, the power control unit may alternate between 14 additional power-on time slices and 14 additional power-off time slices. During each of the remaining 14 five-minute power-on time slices, battery charge percentage increases linearly over the five-minute duration. During each of the remaining 14 two-minute power-off time slices, battery charge does not increase. After approximately 110 minutes intermittent charging, the curve 412 shows an increase in battery charge up to approximately 80% of battery charge capacity. The increase in battery charge resulting from intermittent charging may be very similar to an increase in battery charge that would result from continuous charging. For example, in the same time period (such as approximately 110 minutes), continuous charging may reach approximately 90-100% of battery charge capacity. In yet other cases, continuous charging may not allow the transmitter and receiver coils and electronics to operate at full capacity due to thermal issues. As a result, the charging rate may be much lower and the state of charge may be much lower than 80% of battery capacity in 110 minutes. Thus, continuous charging does not allow for power-off time slices during which heat may dissipate. Hence, by providing wireless power in a time sliced fashion, the power control unit may exhibit charging performance similar to, or sometimes better than, continuous charging while enabling heat dissipation in components of a wireless charging system. In some implementations, the two minutes of time available to cool one or more primary coils, one or more secondary coils or an interface surface may be used by the wireless power transmission apparatus to energize another primary coil for charging another wireless power receiving apparatus. As a result, in the time for continuously charging a single wireless power reception apparatus (e.g. 110 minutes), the wireless power transmission apparatuses described herein may intermittently charge a plurality of wireless power reception apparatuses and achieve better charge states for each as compared to serially charging those wireless power reception apparatuses on the same primary coil.

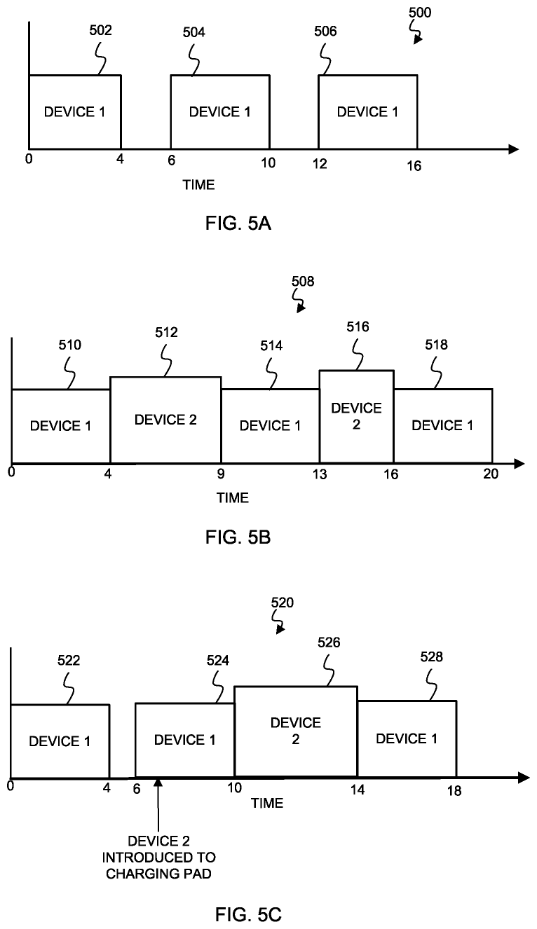

FIG. 5A is an example graphical representation of power-related time slicing associated with charging a single wireless power reception apparatus. A graph 500 shows an example schedule of time slices. A power control unit 132 may provide wireless power to the wireless power reception apparatus according to such schedule of time slices. The graph 500 shows the schedule as time moves forward. According to the schedule of time slices, a first time slice 502 begins at time=0 and ends at time=4, where the time units may be seconds, minutes, hours or any other suitable time metric. Hence, the first time slice 502 has a duration of four time units. A second time slice 504 has a duration of four time units, begins at time=6 and ends at time=10. A third time slice 506 has a duration of four time units and begins at time=12 and ends at time=16. The time slices 502, 504 and 506 may be power-on time slices during which the power control unit 132 provides wireless power to a wireless power reception apparatus. Hence, the scheduled time slices may describe a schedule for wireless power transfer in which the power control unit 132 causes a transmitter circuit to transmit wireless power for four time units, cease transmission of the wireless power for two time units, resume transmission of the wireless power for four time units, and so on.

The time periods during which power is not transferred (such as from time=4 to time=6) may be considered power-off time slices even though the power control unit 132 may not explicitly perform operations to determine such power-off time slices. Instead, the power control unit 132 may arrange those power-on time slices such that there are time gaps between the power-on time slices. For ease of description, those time gaps may be referred to as power-off time slices.

The schedule of time slices can include any suitable type (such as power-on or power-off), number, and duration of time slices. The time slices may be associated with one or more various power-related parameters, such as a specified a voltage, a specified current, a specified wattage, and any other suitable power-related parameter. Hence, when providing wireless power according to a schedule of time slices, the power control unit 132 may customize the wireless power according to the time slices and their associated parameters.

Time slices associated with a particular device can vary in duration and can be associated with different power-related parameters. For example, a schedule for providing wireless power may include power-on time slices having durations of one minute, two minutes, and five minutes (in any suitable order). Particular power-related parameters may be associated with particular durations. For example, in some instances one-minute power-on time slices may be associated with a 15 W power level. Particular power-related parameters (such as wattage or level of current) also may be associated with other scheduling attributes such as where the time slots reside in the schedule. For example, a particular wattage level may be associated with power-on time slices residing in the schedule after the schedule begins.

FIG. 5B is an example graphical representation of power-related time slicing associated with charging two wireless power reception apparatuses. A graph 508 shows an example schedule of time slices. A power control unit 132 may provide wireless power to first and second wireless power reception apparatuses according to such a schedule of time slices. The graph 508 shows the schedule as time moves forward. The graph 508 shows a first time slice 510, a second time slice 512, a third time slice 514, a fourth time slice 516, and a fifth time slice 518. These time slices may be power-on time slices during which wireless power will be provided from a wireless power transmission apparatus.

According to the schedule of time slices, the first time slice 510 is associated with the first wireless power reception apparatus (referred to as device 1) and begins at time=0 and ends at time=4. The time units may be seconds, minutes, hours or any other suitable time metric. The second time slice 512 is associated with the second wireless power reception apparatus (referred to as device 2), begins at time=4 and ends at time=9. The third time slice 514 is associated with the first wireless power reception apparatus, begins at time=9 and ends at time=13. The fourth time slice 516 is associated with the second wireless power reception apparatus and begins at time=13 and ends at time=16. The fifth time slice 518 is associated with the first wireless power reception apparatus and begins at time=16 and ends at time=20.

The first, third and fifth time slices (510, 514 and 518, respectively) are associated with the first wireless power reception apparatus and each has a duration of four time units. The second and fourth time slices (512 and 516, respectively) are associated with the second wireless power reception apparatus and each has a different duration. The second time slice 512 has a duration of five time units, and the fourth time slice 516 has a duration of three time units. As the graph 508 illustrates, the power control unit 132 may determine a schedule for providing wireless power to multiple wireless power reception apparatuses, where the schedule includes time slices of different durations for a particular wireless power reception apparatus. Such a schedule may also include time slices associated with a first wireless power reception apparatus interspersed with time slices associated with a second wireless power reception apparatus.

FIG. 5C is an example graphical representation of dynamically updating a schedule of time slices upon detection of an additional wireless power apparatus. A graph 520 shows an example schedule of time slices. The time slices may be power-on time slices during which wireless power is provided to a wireless power reception apparatus. Initially, the schedule of time slices may be identical to the schedule shown in FIG. 5A, where the schedule includes time slices for charging a first wireless power reception apparatus. However, at time=7, during a time slice 524 associated with the first wireless power reception apparatus (referred to as device 1), a second wireless power reception apparatus (referred to as device 2) may be placed on the charging pad. In response, the power control unit 132 may detect the second wireless power reception apparatus in proximity to a transmitter circuit 130, and dynamically update the schedule to include time slices for the second wireless power reception apparatus. As shown, the power control unit 132 may determine a time slice 526 associated with the second wireless power apparatus and insert the time slice 526 into the schedule. In the graph 520, the power control unit 132 does not preempt the time slice 524 associated with the first wireless power reception apparatus. However, in certain instances, the power control unit 132 may update a schedule in a fashion that preempts a time slice. Preemption refers to modifying or otherwise abandoning one or more time slices before they have finished in order to proceed with an updated schedule.

According to the updated schedule, after completion of the time slice 524, the power control unit 132 may provide power to the second wireless power reception apparatus during the time slice 526. After time slice 526, the power control unit 132 provides wireless power to the first wireless power reception apparatus during time slice 528. When determining an updated schedule, the power control unit 132 may determine any suitable number of new time slices to be inserted into the updated schedule. The original time slices may be rearranged, assigned new durations, and otherwise modified (such as by assigning new power-related parameters). The new time slices may have any suitable duration and may be interspersed with time slices associated with the original schedule.

The power control unit 132 may create an updated schedule based on various information. For example, the power control unit 132 may create an updated schedule based on information about battery charge state, such as information indicating that a particular battery has reached given battery charge state. In response, the power control unit 132 may reduce the duration of power-on time slices associated with the particular battery and increase the duration of power-on time slices associated with one or more other devices.

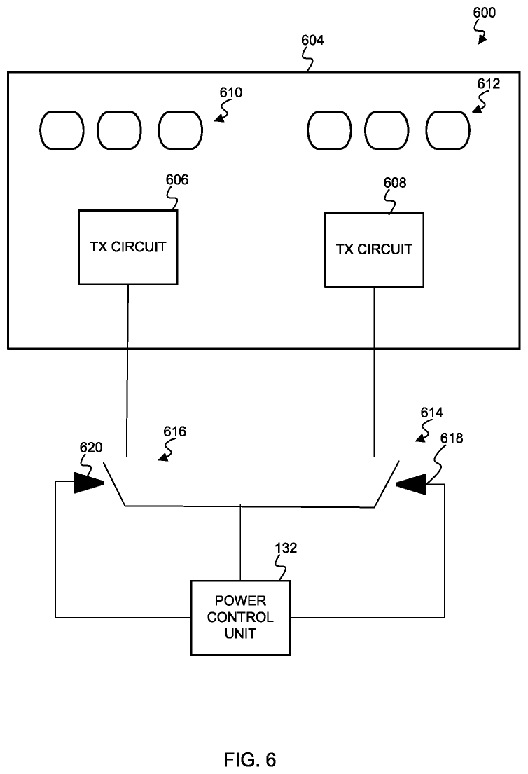

FIG. 6 is a block diagram illustrating a wireless power transmission apparatus 600 in which a power control unit can independently control different transmitter circuits. As shown, the wireless power transmission apparatus 600 may include a power control unit 132, switch controls lines 618 and 620. In some implementations, the power control unit 132 may include drivers or other controllers that are not shown in FIG. 6. The wireless power transmission apparatus 600 also may include switches 614 and 616, transmitter circuits 606 and 608, and user interfaces 610 and 612. Each of the transmitter circuits 606 and 608 may include a single primary coil or a plurality of primary coils.

The wireless power transmission apparatus 600 may include a charging pad 604. The charging pad 604 may include a user interface 610 and a user interface 612. The user interfaces 610 and 612 may present indicia indicating information related to charging wireless power reception apparatuses. For example, the user interfaces 610 and 612 each may include light emitting diodes (LEDs) or liquid crystal displays (LCDs) that indicate device fault status, whether wireless power is being transmitted to an associated device, or whether a device is waiting to receive wireless power. As shown, the wireless power transmission apparatus 600 includes a user interface for with each transmitter circuit. However, the wireless power transmission apparatus 600 may include a single user interface irrespective of the number of transmitter circuits. The user interfaces 610 and 612 may include one or more light presentation devices (such as LEDs, LCDs, etc.), audio presentation devices (such as audio monitors), video presentation devices (such as video monitors), and any other suitable device for presenting information related to charging wireless power reception apparatuses.

During operation, the power control unit 132 may detect a first wireless power reception apparatus in proximity to the transmitter circuit 608. In response, the power control unit 132 may determine a schedule of time slices by which to provide intermittent power to the first wireless power reception apparatus. After determining the schedule, the power control unit 132 may commence to providing intermittent power to the wireless power reception apparatus. To intermittently provide power to the transmitter circuit 608, the power control unit 132 may actuate the switch 614 via the switch control line 618. Thus, the transmitter circuit 608 may provide wireless power to the first wireless power reception device. The user interface 612 may present indicia indicating when wireless power is being transmitted from the transmitter circuit 608, faults detected during the schedule of time slices, and any other suitable information related to providing the wireless power.

While the power control unit 132 is providing power via the transmitter circuit 608, the power control unit 132 may detect a second wireless power reception device in proximity to the transmitter circuit 606. As described above, the power control unit 132 may update the schedule of time slices to accommodate the newly detected device. After updating the schedule, the power control unit 132 may cause the transmitter circuits 606 and 608 to intermittently provide wireless power to both devices according to the updated schedule of time slices. By intermittently providing power, a single power control unit can provide power to multiple transmitter circuits and therefore provide wireless power to multiple wireless power reception apparatuses.

In some instances, instead of providing intermittent power, the power control unit 132 may cause the wireless power transmission apparatus 602 provide continuous wireless power to a wireless power reception apparatus. To provide continuous power, the power control unit 132 may determine a schedule that includes a single time slice during which continuous power is provided to the wireless power reception apparatus. Therefore, the power control unit 132 may provide intermittent wireless power or continuous wireless power to the wireless power reception apparatus.

The charging pad 604 may include an interface surface upon which wireless power reception apparatuses are placed to receive power. The power control unit 132 may receive temperature information from one or more temperature sensors connected to or in proximity of the charging interface. The power unit 132 also may receive temperature information from wireless power reception apparatuses as well as the temperature sensors in the transmitter circuits 606 and 608. The temperature information may include temperatures of the charging interface, transmitter coil(s), receiver coil(s), receiver electronics, or any combination thereof. The power control unit 132 may cease provision of wireless power based on certain temperature information. For example, the power control unit 132 may cease providing wireless power by one of the transmitter circuits if the temperature information indicates that at least a thermal limit has been exceeded. The thermal limit may indicate a maximum acceptable temperature of an area of the interface surface, the receiver coil, the transmitter coil or the receiver electronics. For example, the thermal limit may indicate a maximum acceptable temperature of the portion of the charging pad 604 directly above the transmitter circuit 606. There may be a plurality of thermal limits (also referred to as thresholds) indicating a plurality of maximum acceptable temperatures associated with each of these components, respectively. For example, the maximum acceptable temperature of the interface surface may be 45 degrees Celsius, whereas the temperature threshold of the electronics may be 80 degrees Celsius. The power control unit 132 may continue providing intermittent or continuous power via one or more other transmitter circuits that are not associated with excess temperatures.

The power control unit 132 may cease provision of wireless power based on battery charge information received from a wireless power reception apparatus. For example, the power control unit 132 may cease providing wireless power by one of the transmitter circuits if the battery charge information indicates that a battery charge threshold has been exceeded. For example, if the battery charge threshold has been exceeded for a device receiving power from the transmitter circuit 606, the power control unit 132 may cease providing wireless power to the device. The power control unit 132 may continue providing continuous or intermittent power to other devices via other transmitter circuits. During this change, the power control unit 132, also may change the schedule of time slots for providing power to other devices.

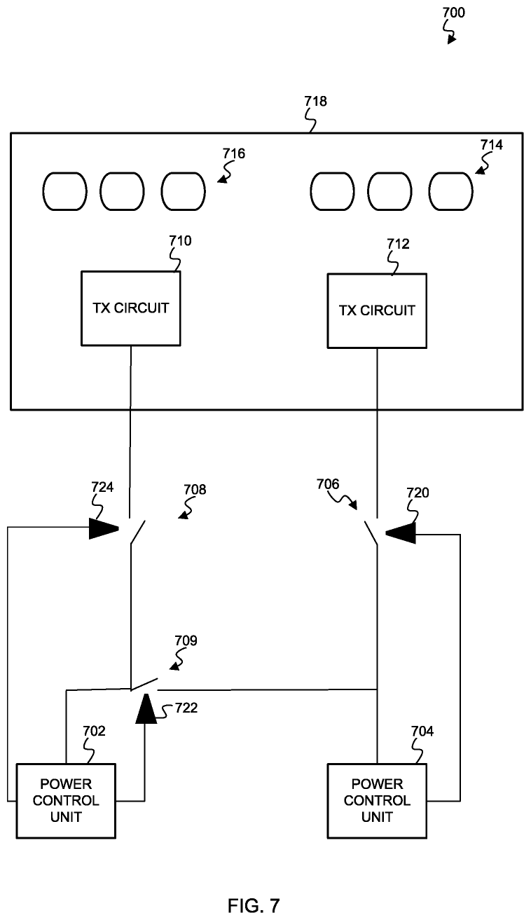

FIG. 7 is a block diagram illustrating a wireless power transmission apparatus 700 in which multiple power control units can cooperatively provide power to a transmitter circuit. As shown, the wireless power transmission apparatus 700 includes power control units 702 and 704, switches 706, 708 and 709, switch control lines 720, 722, and 724. The corresponding switch drivers may be located inside the power control units 702 and 704. The wireless power transmission apparatus 700 also includes transmitter circuits 710 and 712, a charging pad 718, and user interfaces 714 and 716.

Each of the power control units 702 and 704 may operate independently. For example, each power control unit may detect a device in proximity to its associated transmitter circuit and provide continuous or intermittent wireless power to the device. When operating independently, each of the power control units 702 and 704 may utilize any of the techniques described herein for providing wireless power to a wireless power reception apparatus.

Each of the power control units 702 and 704 may have their own power capabilities. For example, each power control unit may be capable of providing 5 W of power to a transmitter circuit. By working together, the power control units 702 and 704 may provide an increased level of power—such as more power than each would individually provide. For example, by closing the switch 709, the power control units 702 and 704 may cooperatively provide 10 W of power to the transmitter circuit 710. The power control unit 702 may intermittently actuate the switch 708 to intermittently provide the increased level of power to the transmitter circuit 710. Alternatively, the power control unit 702 may close the switch 708 to continuously provide the increased level of power to the transmitter circuit 710. Under these conditions, the power control units 702 and 704 may operate at the same frequency to share the power fed to the transmitter circuit 710.

The power control units 702 and 704 may provide power to a single transmitter circuit according to a schedule of time slices. For example, the schedule of time slices may include first time slices that call for 10 W of power and second time slices that call for 5 W of power, where the first and second time slices are interspersed. During the first time slices, the power control units 702 and 704 may cooperatively provide 10 W of power to a transmitter circuit 710. During the second time slices, one of the power control units may individually provide 5 W of power to the transmitter circuit 710 or 712. As another example, the power control units 702 and 704 may provide increased power, where a schedule of time slices may include first time slices that call for 10 W of power and second time slices that call for 0 W of power, where the first and second time slices are interspersed. During the first time slices, the power control units 702 and 704 may cooperatively provide 10 W of power to the transmitter circuit 710. During the second time slices, neither the power control unit 702 nor 704 provides power to the transmitter circuit 710. During time slices in which no power is provided, one of the power control units 702 and 704 may provide power to a different transmitter circuit (such as the transmitter circuit 712).

In some implementations, one of the power control units 702 and 704 may act as a “superior controller” that determines time slice schedules for providing wireless power and the other may act as a “subordinate controller” that cooperatively caries-out the schedules. In some implementations, the power control units 702 and 704 may act as peers that cooperatively determine and carry out time slice schedules for providing wireless power to power reception apparatuses.

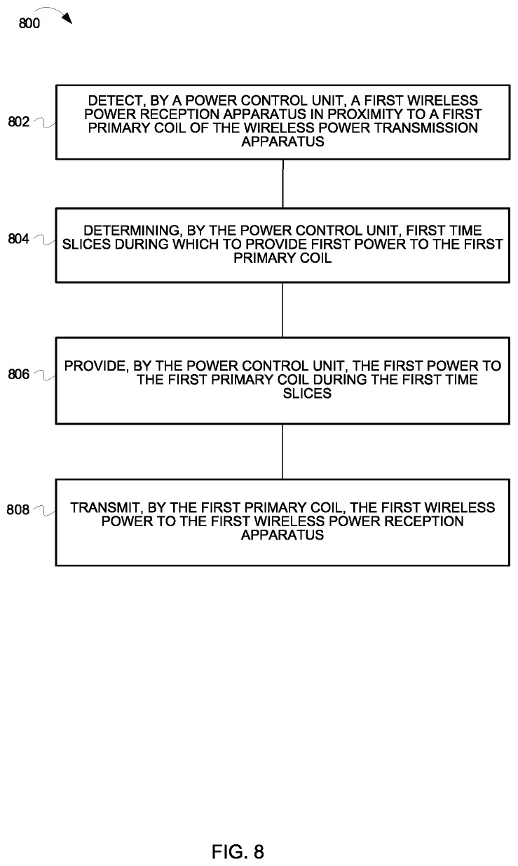

FIG. 8 is a flow diagram illustrating example operations of a process for providing wireless power to a wireless power reception apparatus. For brevity, the operations are described as performed by an apparatus. The operations of the process 800 may be implemented by a wireless power transmission apparatus as described herein. For example, the process 800 may be performed by a wireless power transmission apparatus 110 and the power control unit 132 described with reference to FIG. 1, the wireless power transmission apparatus 600 described with reference to FIG. 6, or the wireless power transmission apparatus 700 and the power control units 702 and 704 described with reference to FIG. 7.

At block 802, the apparatus may detect a first wireless power reception apparatus in proximity to a first primary coil of the wireless power transmission apparatus.

At block 804, the apparatus may determine first time slices during which to power a first primary coil to cause the first primary coil to transmit a first wireless power to a first wireless power reception apparatus.

At block 806, the apparatus may transmit, by the first primary coil, the first wireless power to the first wireless power reception apparatus during the first time slices.

FIG. 9 shows a block diagram of an example apparatus for use in wireless power system according to some implementations. In some implementations, the apparatus 900 may be a wireless power transmission apparatus (such as the wireless power transmission apparatus 110) described herein. In some implementations, the apparatus 900 may be an example of the power control unit 132 described with reference to FIG. 1, the wireless power transmission apparatus 600 described with reference to FIG. 6, or the wireless power transmission apparatus 700 and the power control units 702 and 704 described with reference to FIG. 7. The apparatus 900 can include a processor 902 (possibly including multiple processors, multiple cores, multiple nodes, or implementing multi-threading, etc.). The apparatus 900 also can include a memory 906. The memory 906 may be system memory or any one or more of the possible realizations of computer-readable media described herein. The apparatus 900 also can include a bus 911 (such as PCI, ISA, PCI-Express, HyperTransport®, InfiniBand®, NuBus,® AHB, AXI, etc.).

The apparatus 900 may include one or more controller(s) 962 configured to manage multiple primary or secondary coils (such as a coil array 964). In some implementations, the controller(s) 962 can be distributed within the processor 902, the memory 906, and the bus 911. The controller(s) 962 may perform some or all of the operations described herein. For example, the controller(s) 962 may be a power controller, such as the power control unit 132 described with reference to FIG. 1 or the power controller 538 described with reference to FIG. 5.

The memory 906 can include computer instructions executable by the processor 902 to implement the functionality of the implementations described with reference to FIGS. 1-8. Any one of these functionalities may be partially (or entirely) implemented in hardware or on the processor 902. For example, the functionality may be implemented with an application specific integrated circuit, in logic implemented in the processor 902, in a co-processor on a peripheral device or card, etc. Further, realizations may include fewer or additional components not illustrated in FIG. 9. The processor 902, the memory 906, and the controller(s) 962 may be coupled to the bus 911. Although illustrated as being coupled to the bus 911, the memory 906 may be coupled to the processor 902.

FIGS. 1-9 and the operations described herein are examples meant to aid in understanding example implementations and should not be used to limit the potential implementations or limit the scope of the claims. Some implementations may perform additional operations, fewer operations, operations in parallel or in a different order, and some operations differently.

The figures, operations, and components described herein are examples meant to aid in understanding example implementations and should not be used to limit the potential implementations or limit the scope of the claims. Some implementations may perform additional operations, fewer operations, operations in parallel or in a different order, and some operations differently.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, in some aspects of the subject matter described in this specification can be implemented as software. For example, various functions of components disclosed herein, or various blocks or steps of a method, operation, process or algorithm disclosed herein can be implemented as one or more modules of one or more computer programs. Such computer programs can include non-transitory processor-executable or computer-executable instructions encoded on one or more tangible processor-readable or computer-readable storage media for execution by, or to control the operation of, a data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A wireless power transmission apparatus comprising:
a first primary coil of a plurality of primary coils configured to transmit a first wireless power to a first wireless power reception apparatus.
a power control unit configured to
detect the first wireless power reception apparatus in proximity to the first primary coil of the wireless power transmission apparatus, and
determine first time slices during which to power the first primary coil to cause the first primary coil to transmit the first wireless power to the first wireless power reception apparatus.

2. The wireless power transmission apparatus of claim 1, where in the power control unit is further configured to:
determine second time slices during which to cease transmission of the first wireless power to the first wireless power reception apparatus, wherein the first time slices are interspersed with the second time slices, and
cause the first primary coil to cease transmission of the first wireless power to the first wireless power reception apparatus during the second time slices.

3. The wireless power transmission apparatus of claim 2, wherein a battery is associated with the first wireless power reception apparatus, wherein the battery is configured to charge up to a percentage of battery capacity in a first time period, wherein the first time period is substantially similar to a second time period for continuously charging the battery up to the charge percentage.

4. The wireless power transmission apparatus of claim 2, wherein the cessation of transmission of the first wireless power keeps a temperature below a thermal limit in one or more components selected from a group consisting of an interface surface, a transmitter coil, a receiver coil, and electronics in the wireless power transmission apparatus.

5. The wireless power transmission apparatus of claim 1, where in the power control unit is further configured to:
determine, during one or more of the first time slices, that a thermal limit has been exceeded, and
cease, in response to the determination that thermal limit has been exceeded, provision of the first wireless power to the first wireless power reception apparatus during the one or more of the first time slices.

6. The wireless power transmission apparatus of claim 5, wherein the thermal limit indicates a maximum temperature of an interface surface of the wireless power transmission apparatus.

7. The wireless power transmission apparatus of claim 1, wherein the first wireless power reception apparatus is associated with a device rating, and wherein a duration of the first time slices is based, at least in part, on the device rating.

8. The wireless power transmission apparatus of claim 1, wherein
the power control unit is further configured to:
detect a second wireless power reception apparatus in proximity to a second primary coil of the plurality of primary coils, and
determine second time slices during which to power the second primary coil to cause the second primary coil to transmit a second wireless power to the second wireless power reception apparatus, wherein the second time slices are interspersed with the first time slices; and
the second primary coil configured to transmit the second wireless power to the second wireless power reception apparatus.

9. The wireless power apparatus of claim 8, wherein
the power control unit is further configured to:
determine that a battery charge threshold associated with the second wireless power reception apparatus has been exceeded, and
cause the second primary coil to cease transmission of the second wireless power during one or more of the second time slices in response to the determination that the battery charge threshold has been exceeded; and
the second primary coil further configured to cease transmission of the second wireless power to the second wireless power reception apparatus in response to the determination that the battery charge threshold has been exceeded.

10. The wireless power transmission apparatus of claim 8, wherein each of the first time slices has a first duration and each of the second time slices has a second duration, and wherein
the power control unit further configured to
determine a charge state of a battery associated with the second wireless power reception apparatus,
increase the first duration based on the charge state, and
decrease the second duration based on the charge state.

11. The wireless power transmission apparatus of claim 8, wherein each of the first time slices is of a first duration and each of the second time slices is of a second duration, and wherein
the power control unit further configured to
determine a user-configurable charging priority associated with the second wireless power reception apparatus, and
modify the first duration based on the user-configurable charging priority.

12. The wireless power transmission apparatus of claim 8, further comprising:
a first user interface (UI) configured to present indicia indicating charging status of at least one of the first primary coil and the second primary coil.

13. The wireless power transmission apparatus of claim 1 further comprising:
another power control unit configured to
detect a second wireless power reception apparatus in proximity to a second primary coil of the plurality of primary coils,
determine second time slices during which to power the second primary coil to cause the second primary coil to transmit a second wireless power to the second wireless power reception apparatus, and
provide the second wireless power to the second primary coil during the second time slices; and
the second primary coil configured to transmit the second wireless power to the second wireless power reception apparatus.

14. The wireless power transmission apparatus of claim 13, wherein the second time slices are interspersed with the first time slices.

15. The wireless power transmission apparatus of claim 1, further comprising:
another power control unit configured to power the first primary coil during the first time slices, wherein the first wireless power is based on power from each of the power control units.

16. A method for controlling a wireless power transmission apparatus, the method comprising:
detecting, by a power control unit of the wireless power transmission apparatus, a first wireless power reception apparatus in proximity to a first primary coil of the wireless power transmission apparatus;
determining, by the power control unit, first time slices during which to power a first primary coil to cause the first primary coil to transmit a first wireless power to a first wireless power reception apparatus; and
transmitting, by the first primary coil, the first wireless power to the first wireless power reception apparatus during the first time slices.

17. The method of claim 16, further comprising:
determining second time slices during which to cease transmission of the first wireless power to the first wireless power reception apparatus, wherein the first time slices are interspersed with the second time slices; and
causing the first primary coil to cease transmission of the first wireless power to the first wireless power reception apparatus during the second time slices.

18. The method of claim 17, wherein a battery is associated with the first wireless power reception apparatus, wherein the battery is configured to charge up to a first percentage of battery capacity in a first time period, wherein the first time period is substantially similar to a second time period for continuously charging the battery up to the charge percentage.

19. The method of claim 17, wherein the cessation of transmission of the first wireless power keeps a temperature below a thermal limit in one or more of an interface surface, a transmitter coil, a receiver coil, and electronics in the wireless power transmission apparatus.

20. The method of claim 16, further comprising:
determining, during one or more of the first time slices, that a thermal limit has been exceeded; and
ceasing, in response to the determination that thermal limit has been exceeded, provision of the first wireless power to the first wireless power reception apparatus during the one or more of the first time slices.

21. The method of claim 20, wherein the thermal limit indicates a maximum temperature of an interface surface of the wireless power transmission apparatus.

22. The method of claim 16, wherein the first wireless power reception apparatus is associated with a device rating, and wherein a duration of the first time slices is based, at least in part, on the device rating.

23. The method of claim 16, further comprising:
detecting, by the power control unit, a second wireless power reception apparatus in proximity to a second primary coil of the wireless power transmission apparatus;
determining, by the power control unit, second time slices during which to power the second primary coil to cause the second primary coil to transmit a second wireless power to the second wireless power reception apparatus, wherein the second time slices are interspersed with the first time slices; and
transmitting, by the second primary coil, the second wireless power to the second wireless power reception apparatus.

24. method of claim 23, further comprising:
determining that a battery charge threshold associated with the second wireless power reception apparatus has been exceeded, and
causing the second primary coil to cease transmission of the second wireless power during one or more of the second time slices in response to the determination that the battery charge threshold has been exceeded.

25. The method of claim 23, wherein each of the first time slices has a first duration and each of the second time slices has a second duration, wherein the method further comprises:
determining, by the power control unit, a charge state of a battery associated with the second wireless power reception apparatus;
increasing, by the power control unit, the first duration based on the charge state; and
decreasing, by the power control unit, the second duration based on the charge state.

26. The method of claim 23, wherein each of the first time slices is of a first duration and each of the second time slices is of a second duration, wherein the method further comprises:
determining, by the power control unit, a user-configurable charging priority associated with the second wireless power reception apparatus, and
modifying, by the power control unit, the first duration based on the user-configurable charging priority.

27. The method of claim 23, further comprising:
presenting, by a first user interface, indicia indicating charging status of at least one of the first primary coil and the second primary coil.

28. The method of claim 16, further comprising:
detecting, by another power control unit, a second wireless power reception apparatus in proximity to a second primary coil of the plurality of primary coils;
determining, by the other power control unit, second time slices during which to power the second primary coil to cause the second primary coil to transmit a second wireless power to the second wireless power reception apparatus; and
providing, by the other power control unit, the second wireless power to the second primary coil during the second time slices; and
transmitting, by the second primary coil, the second wireless power to the second wireless power reception apparatus.

29. The method of claim 28, wherein the second time slices are interspersed with the first time slices.

30. The method of claim 16 further comprising:
powering, by another power control unit, the first primary coil during the first time slices, wherein the first wireless power is based on power from each of the power control units.

31. A wireless power transmission apparatus comprising:
a first primary coil of a plurality of primary coils configured to transmit a first wireless power to a first wireless power reception apparatus;
a first power control unit configured to
detect the first wireless power reception apparatus in proximity to the first primary coil of the wireless power transmission apparatus, and
determine first time slices during which to power the first primary coil to cause the first primary coil to transmit the first wireless power to the first wireless power reception apparatus; and
a second power control unit configured to
determine second time slices during which to power the first primary coil to cause the first primary coil to increase the first wireless power.

32. The wireless power transmission apparatus of claim 31 further comprising:
a second primary coil of the plurality of primary coils configured to transmit second wireless power to a second wireless power reception apparatus;
wherein the second power control unit is further configured to
determine third time slices during which to power the second primary coil to cause the second primary coil to transmit the second wireless power to the second wireless power reception apparatus.

33. The wireless power transmission apparatus of claim 31, the second power control unit further configured to:
determine fourth time slices during which to cease transmission of the second wireless power to the first wireless power reception apparatus, wherein the first time slices are simultaneous with the second time slices.
